(19) United States
(12) Patent Application Publication
(10) Pub. No.: US 2026/0359909 A1
(43) Pub. Date: Nov. 12, 2026

(54) SYSTEM AND METHOD FOR DATA-DRIVEN PRIORITIZATION OF LEGAL INTAKE LEADS BASED ON STRUCTURED INCIDENT METADATA

(71) Applicant: Worklution, Inc., Charlotte, NC (US)

(72) Inventor: Cierra Faith GROSS, Charlotte, NC (US)

(21) Appl. No.: 19/672,100

(22) Filed: May 8, 2026

Related U.S. Application Data
(60) Provisional application No. 63/803,096, filed on May 9, 2025.

(51) Int. Cl. G06Q 50/18; G06F 16/22

(52) U.S. Cl. CPC G06Q 50/18; G06F 16/2246

(57) ABSTRACT

A computer-implemented method, program products, and computer systems comprise program code executing on one or more processors, generates a user interface comprising a predefined structured input interface. The program code obtains data comprising incident entries. The program code maps a given incident entry to legal issue categories. The program code identifies a parent node comprising a profile for the user in a hierarchical data structure. The program code updates the hierarchical data structure by generating a child node representing the given incident entry. The program code performs a cross-entry analysis across a portion of the update hierarchical data structure, to generate evaluation metrics. The program code applies a rule-based scoring engine to generate a composite prioritization score for the given incident entry as a function of the evaluation metrics. The program code outputs ranked case profiles through an output interface.

### CROSS-REFERENCE TO RELATED APPLICATIONS

This application claims the benefit of and priority to U.S. Provisional Patent Application No. 63/803,096, filed May 9, 2025, entitled "System and Method for Data-Driven Prioritization of Legal Intake Leads Based on Structured Incident Metadata," the entire contents of which is incorporated herein by reference in its entirety.

### BACKGROUND

Legal intake processes are traditionally conducted through unstructured communication channels, including telephone conversations, email submissions, and open-ended narrative forms. These approaches introduce significant variability in the information received from prospective clients and preclude standardized processing, cross-submission analysis, or automated evaluation of legal merit or urgency.

Existing legal intake software solutions store each intake submission as an independent and isolated record. These systems do not aggregate related submissions into a unified data structure and thus lack mechanisms to evaluate patterns, escalation trends, or temporal relationships that may span multiple incidents submitted by the same user over time.

Furthermore, when new information is received regarding an existing matter, existing systems require either a full re-computation of all previously stored records or manual reassessment by intake personnel. Neither approach scales efficiently as caseload volume grows.

Existing systems further lack the capability to detect recurring incident patterns or severity escalation trends across temporally distributed submissions. As a result, high-priority matters may be delayed in reaching qualified legal professionals, and lower-priority submissions may be inadvertently elevated.

### SUMMARY

Shortcomings of the prior art are overcome and additional advantages are provided through the provision of a method for automatically evaluating, transforming, and prioritizing data. The method includes, for instance: generating, by one or more processors, a user interface comprising a predefined structured input interface; continuously obtaining, by the one or more processors, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry; based on obtaining the given incident entry, mapping, by the one or more processors, utilizing pre-defined data object stored in a mapping layer communicatively coupled to the user interface, based on an incident type of the given incident entry, the given incident entry to one or more legal issue categories; identifying, by the one or more processors, a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface; updating, by the one or more processors, the hierarchical data structure by generating a child node representing the given incident entry and the mapped one or more legal issue categories; based on the updated hierarchical data structure, generating, by the one or more processors, based on performing a cross-entry analysis across a portion of the update hierarchical data structure, evaluation metrics for one or more structured incident entries stored in the hierarchical data structure wherein the one or more structured incident entries comprise the given incident entry; applying, by the one or more processors, a rule-based scoring engine to generate a composite prioritization score for the given incident entry as a function of the evaluation metrics; and outputting, by the one or more processors, ranked case profiles through an output interface, wherein a case profile of the case profiles is associated with the given incident entry in a context of the updated hierarchical data structure, wherein the case profiles are ranked based on their respective composite prioritization scores.

Shortcomings of the prior art are overcome and additional advantages are provided through the provision of a computer program product for automatically evaluating, transforming, and prioritizing data. The computer program product comprises a storage medium readable by a processing circuit and storing instructions for execution by the processing circuit for performing a method. The method includes, for instance: generating, by the one or more processors, a user interface comprising a predefined structured input interface; continuously obtaining, by the one or more processors, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry; based on obtaining the given incident entry, mapping, by the one or more processors, utilizing pre-defined data object stored in a mapping layer communicatively coupled to the user interface, based on an incident type of the given incident entry, the given incident entry to one or more legal issue categories; identifying, by the one or more processors, a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface; updating, by the one or more processors, the hierarchical data structure by generating a child node representing the given incident entry and the mapped one or more legal issue categories; based on the updated hierarchical data structure, generating, by the one or more processors, based on performing a cross-entry analysis across a portion of the update hierarchical data structure, evaluation metrics for one or more structured incident entries stored in the hierarchical data structure wherein the one or more structured incident entries comprise the given incident entry; applying, by the one or more processors, a rule-based scoring engine to generate a composite prioritization score for the given incident entry as a function of the evaluation metrics; and outputting, by the one or more processors, ranked case profiles through an output interface, wherein a case profile of the case profiles is associated with the given incident entry in a context of the updated hierarchical data structure, wherein the case profiles are ranked based on their respective composite prioritization scores.

Shortcomings of the prior art are overcome and additional advantages are provided through the provision of a system for automatically evaluating, transforming, and prioritizing data. The system can include: a memory; one or more processors communicatively coupled to the one or more sensors and in communication with the memory; and program instructions executable by the one or more processors, via the memory, to perform a method, the method comprising: generating, by the one or more processors, a user interface comprising a predefined structured input interface; continuously obtaining, by the one or more processors, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry; based on obtaining the given incident entry, mapping, by the one or more processors, utilizing pre-defined data object stored in a mapping layer communicatively coupled to the user interface, based on an incident type of the given incident entry, the given incident entry to one or more legal issue categories; identifying, by the one or more processors, a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface; updating, by the one or more processors, the hierarchical data structure by generating a child node representing the given incident entry and the mapped one or more legal issue categories; based on the updated hierarchical data structure, generating, by the one or more processors, based on performing a cross-entry analysis across a portion of the update hierarchical data structure, evaluation metrics for one or more structured incident entries stored in the hierarchical data structure wherein the one or more structured incident entries comprise the given incident entry; applying, by the one or more processors, a rule-based scoring engine to generate a composite prioritization score for the given incident entry as a function of the evaluation metrics; and outputting, by the one or more processors, ranked case profiles through an output interface, wherein a case profile of the case profiles is associated with the given incident entry in a context of the updated hierarchical data structure, wherein the case profiles are ranked based on their respective composite prioritization scores.

Methods, systems, and computer program products relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a block diagram illustrating an example system architecture including a user device, a server system, a database, and an output interface, in accordance with an embodiment of the disclosure;

FIG. 2 is a flow diagram illustrating a structured data intake process, including receipt of structured incident entries through predefined input fields and mapping of incident types to legal issue categories, in accordance with an embodiment of the disclosure;

FIG. 3 is a flow diagram illustrating a rule-based scoring process, including computation of component scores and generation of a composite prioritization score, in accordance with an embodiment of the disclosure;

FIG. 4 is a diagram illustrating a hierarchical case profile data structure into which structured incident entries are aggregated, in accordance with an embodiment of the disclosure;

FIG. 5 is a diagram illustrating prioritization and ranking of case profiles based on composite prioritization scores, in accordance with an embodiment of the disclosure;

FIG. 6 is a flow diagram illustrating incremental updating of evaluation metrics in response to newly received incident entries, in accordance with an embodiment of the disclosure;

FIG. 7 is a workflow of a given use case provided for illustrative purposes, only;

FIG. 8 depicts a computer system configured to perform one or more aspects of an embodiment of the disclosure; and

FIG. 9 depicts a computer program product incorporating one or more aspects of the present disclosure.

### DETAILED DESCRIPTION

The computer-implemented methods, computer program products, and computer systems described herein comprise program code executing on one or more processors which evaluates legal intake data and transforms these data by generating comprehensive, ranked outputs. As will be described in greater detail herein, in certain of the examples, program code executing on one or more processors structures, persistently stores, aggregates, analyzes, and dynamically prioritizing data. The program code manages and interprets these data by applying structured incident metadata, incremental computation, and/or rule-based scoring engines. To illustrate the functionality of the examples herein, the legal intake data is utilized as the data obtained and transformed by the examples herein. However, these data are utilized in the examples for illustrative purposes only and not to introduce any limitations. One of skill in the art will recognize that the technical architecture introduced herein can be applied to different forms or types of intake data and used to produce comprehensive, ranked, results.

The following detailed description is presented to enable any person skilled in the art to make and use the disclosed inventions. For purposes of explanation, specific details are set forth to provide a thorough understanding of the present disclosure. However, these specific details are not required to practice the invention, and other embodiments are possible. To avoid obscuring the disclosure with unnecessary detail, well-known circuits, structures, and techniques are not described in detail. As understood by one of skill in the art, the accompanying figures are provided for ease of understanding and illustrate aspects of certain embodiments of the present invention. The invention is not limited to the embodiments depicted in the figures.

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code.

The computer-implemented methods, computer program products, and computer systems comprise program code executing on one or more processors which prioritizes intake leads. As aforementioned, legal intake data is used throughout to illustrates but not to limit the functionality of the examples described herein. Thus, the intake leads can be legal intake leads. In some examples, program code executing on one or more processors obtains, through a predefined structured user interface (UI), a plurality of structured incident entries associated with a user, maps each incident entry to one or more (e.g., legal) issue categories using a mapping layer. In some examples, a structured incident entry comprises standardized fields including, but not limited to incident type, a timestamp, an actor identifier, and an impact indicator. The program code aggregates the structured incident entries into a hierarchical data structure comprising a case profile associated with the user. The program code generates a plurality of evaluation metrics based on cross-entry analysis of the aggregated structured incident entries. In some examples, the evaluation metrics includes, but in not limited to, a severity metric, a documentation metric, a recency metric, a consistency metric, and/or a pattern-based metric. In examples where the program code generates a pattern-based metric, the program code generates this metric by detecting at least one of: (i) recurring incident types (based on the program code determining that the same incident type occurs above a predefined frequency threshold within a defined time window); and/or (ii) temporal escalation (based on the program code comparing severity values across successive timestamps and identifying an increasing trend in severity values over time). The program code generates a composite prioritization score for the case profile using a rule-based scoring engine. The program code incrementally updates the composite prioritization score in response to newly received incident entries. In some examples, the program code makes these updates without recomputing all previously stored entries. The program code outputs ranked case profiles for review through an output interface.

The computer-implemented methods, computer program products, and computer systems described herein are inextricably tied to computing and are directed to a practical application transforming unstructured intake data into ranked profiles and also, continuously updating and improving the computer architecture which enables the generation of this output. For examples, the program code in the examples herein incrementally updates one or more of a plurality of evaluation metrics and the composite prioritization score in response to receipt of a new structured incident entry associated with the case profile (generated by the program code), without recomputing evaluation metrics unaffected by the new structured incident entry, which improves the computational efficiency of the system overall. Additionally, the program code generates and outputs the aforementioned output ranked case profiles through an output interface (generated by the program code). The program code ranks these profiles based on their respective composite prioritization scores. The examples herein are directed to a practical application at least because they address a need for a computer-implemented system that receives structured intake data through a predefined schema, aggregates temporally distributed incident entries into a persistent hierarchical data structure, computes evaluation metrics across multiple submissions using incremental computation, detects recurring patterns and escalation trends, and generates dynamic prioritization scores that are updated in response to newly received data without full re-computation. As discussed above, existing systems do not include this functionality nor utilize a computing architecture which enables the advantages discussed herein. As will be described in greater detail herein, program code, executing on one or more processors, in the examples herein transforms unstructured or semi-structured data into structured data entries conforming to a predefined schema, the transformation of these data enabling their usage for the practical applications described herein. The examples herein are also inextricably ties to computing because the program code, based on obtaining unstructured data, organizes these data into structured entries within a persistent hierarchical data structure and it is this persistent hierarchical data structure which enables the program code to aggregate these data across temporally distributed submissions. The examples herein are also directed to the practical application of increasing processing efficiencies as various aspects of the technical architecture enable the generation of the output in an efficient manner. To that end, the program code performs incremental computation such that evaluation metrics update in response to new data without full re-computation of stored entries. Additionally, program code in the examples herein automatically detect recurring incident patterns and severity escalation trends across multiple submissions based on the persistent hierarchical data structure the program code utilizes to organize and store what was formerly unstructured data.

The examples herein are also inextricably tied to computing and directed to a practical application at least because they are implemented through a specialized computing architecture configured to ingest, normalize, classify, correlate, and analyze heterogeneous data. The claimed invention does not merely perform abstract mental evaluation of information but instead improves the operation of computer-based analytical systems through machine-executed processing workflows that transform raw incoming data into structured, machine-evaluable representations capable of supporting automated operational decisions. The system addresses problems arising specifically in computing environments, including the processing of high-volume, rapidly changing data sets, real-time aggregation of disparate data sources, and automated generation of operational scoring metrics that cannot practically be performed mentally or manually. Moreover, the generated scores and ranking generates by the program code are not merely informational outputs but are used within the computing environment to drive downstream system functionality, including prioritization, resource allocation, anomaly detection, workflow triggering, and adaptive system behavior, thereby tying the claimed invention to a concrete technological application.

The examples herein provide significantly more than existing intake systems, and in particular, (but not exclusively) existing legal intake systems. Existing intake systems rely on static, single-instance submissions that are typically unstructured or semi-structured. Each submission is stored independently, and relationships between submissions from the same user are not captured, processed, or leveraged by the system. As a result, existing systems are incapable of efficiently processing relationships across multiple submissions and exhibit no capability for analyzing temporally distributed data to detect escalating severity or recurring incident patterns. The examples herein represent a technical improvement in the way computing systems structure, store, and process legal intake data. The technical improvements result in a more effective and efficient system. As will be described in greater detail herein, unlike in existing systems, the program code in the examples herein can transform unstructured or semi-structured intake data into structured data entries conforming to a predefined schema. The program code can organize structured entries within a persistent hierarchical data structure that enables aggregation across temporally distributed submissions. The program code can perform incremental computations such that evaluation metrics update in response to new data without full re-computation of stored entries. The program code can automatically detect recurring incident patterns and severity escalation trends across multiple submissions. In addition to the efficiencies and improvements in results obtained by users of computing environments which integrate aspects of the examples herein, the computing environment itself is improved because aspects of the examples herein reduce computational overhead (especially when compared to existing approaches), enable processing of relationships that span multiple data records, and generate prioritization outputs which are not enabled by the technical architectures of existing systems, which are single-record intake systems.

The examples herein also provide significantly more than existing systems because the examples comprise a particularized and non-conventional arrangement of computing components and processing operations that improve the efficiency, scalability, and functionality of computerized data processing environments. Unlike existing systems that merely collect and display information, the claimed architecture performs coordinated intake, aggregation, and scoring and ranking operations using specialized processing mechanisms such as dynamic data normalization, structured feature extraction, adaptive thresholding, correlation analysis, and automated score generation across aggregated data sets. These operations enable the system to process large-scale heterogeneous data in real time while reducing computational inefficiencies associated with prior systems, including inconsistent normalization, excessive processing overhead, and inability to generate meaningful aggregate operational metrics at scale. Accordingly, the combination of aspects reflects significantly more than well-understood, routine, or conventional activity and instead constitutes a specific technological improvement to the functioning of the underlying computing system itself.

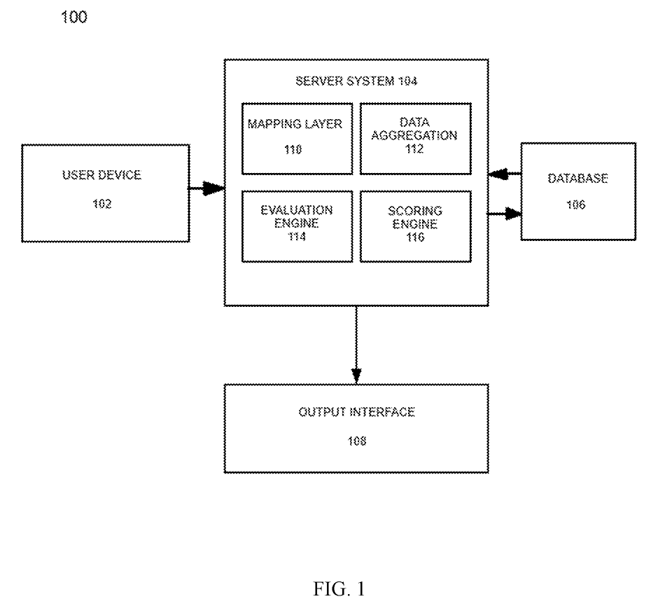

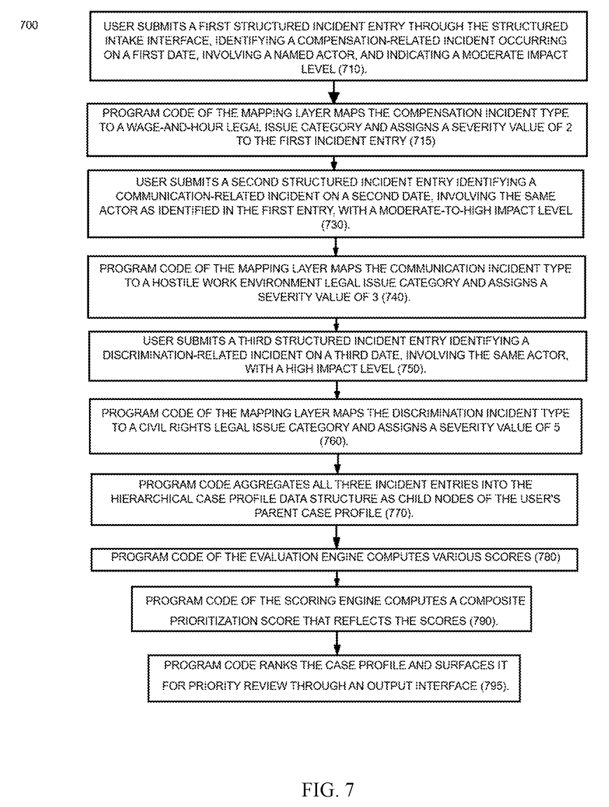

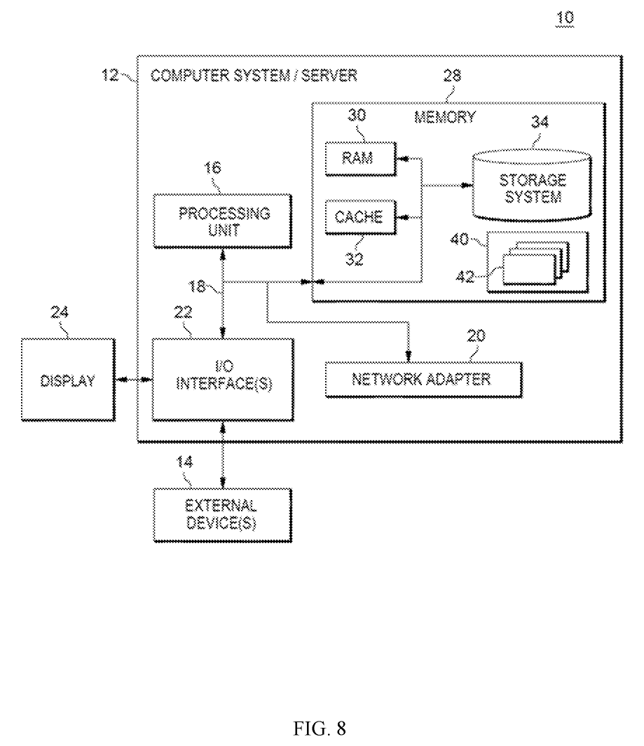

FIGS. 1-6 illustrate various aspects of the some of the examples herein. FIG. 7 illustrates a computing node, which could be a cloud computing node, in which certain of the aspects of the examples herein can be implemented. FIG. 8 is a computer program product which can perform certain of the aspects of the examples herein.

FIG. 1 illustrates an example of a computing architecture 100 into which various aspects of the examples herein can be implemented. The computing architecture 100 includes a user device 102, a server system 104, a database 106, and an output interface 108.

In some examples, the user device 102 is configured to present a structured intake interface to a user and transmit structured incident entries to server system 104. In certain examples, user device 102 comprises a personal computer, mobile device, tablet, and/or other computing device capable of executing a web application or dedicated software client. The structured intake interface constrains user input to predefined fields, including at minimum an incident type field, a timestamp field, an actor identifier field, and an impact indicator field. The structured intake interface

In this non-limited example, the server system 104 includes one or more processors and a memory storing instructions configured to process structured incident entries received from user device 102. Server system 104 includes a mapping layer 110, a data aggregation module 112, an evaluation engine 114, and a scoring engine 116, each described in detail below.

As will be described in greater detail herein, program code executing on one or more processors utilize the database 106 to store hierarchical case profile data structures, associated structured incident entries, mapping tables, and computed evaluation metrics. In certain examples, database 106 comprises one or more of a relational database, a document-oriented database, and/or a combination thereof.

Output interface 108 presents prioritized case profiles for review by legal professionals or intake personnel. In certain examples, output interface 108 comprises a dashboard application displaying ranked case profiles and associated prioritization scores.

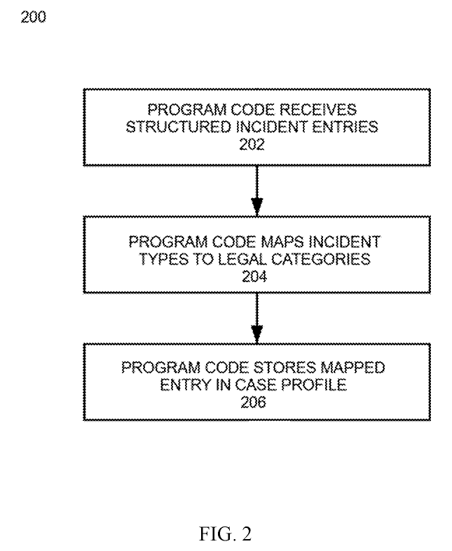

FIG. 2 illustrates a structured data intake process 200 in accordance with aspects of some examples described herein. Aspects of a technical architecture of the examples herein are referenced as performing various aspects. However, as understood by one of skill in the art, the functionality can be accomplished by various layers and modules depending on the configuration of the technical environment. Thus, the examples herein are provided for illustrative purposes only and not to introduce any limitation.

Referring to FIG. 2, program code executing on one or more processors obtains one or more structured incident entries from a user through a predefined structured input interface (generated by program code and displayed in a UI) (202). The program code of the structured input interface constrains user submissions to a predefined schema comprising standardized fields. In one example, the standardized fields include at least: (a) an incident type field, to which the program code assigns a value selected from a predefined taxonomy of incident types; (b) a timestamp field, which the program code stores to reflect the date and time of the incident as reported by the user; (c) an actor identifier field, which identifies the individual, entity, or role alleged to have been involved in the incident; and (d) an impact indicator field, which captures the nature and extent of the impact experienced by the user.

Program code of a mapping layer 110 associates each incident type with one or more legal issue categories (202). In some examples, mapping layer 110 is implemented as a lookup table stored in memory, wherein each key in the lookup table corresponds to a predefined incident type and each associated value identifies one or more legal issue categories. The lookup table enables efficient retrieval of legal issue category assignments for each incoming incident entry and can be updated independently of the scoring engine.

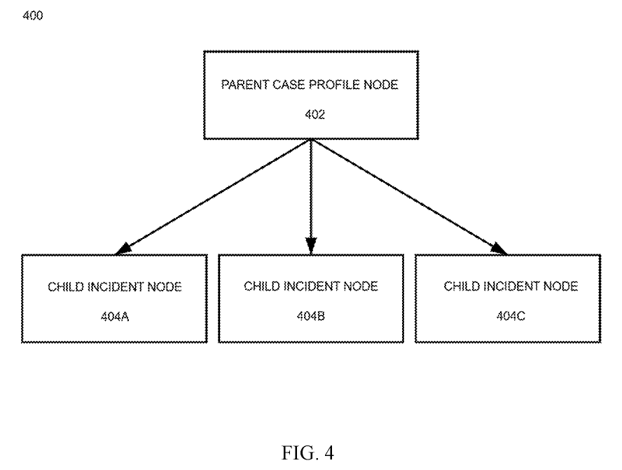

Program code stores each structured incident entry, together with its mapped legal issue category, as a child node of a hierarchical data structure representing a parent case profile associated with the user (206). The parent-child node structure is described in greater detail herein and illustrated in FIG. 4.

Referring to FIG. 4, FIG. 4 illustrates an example hierarchical case profile data structure 400 in accordance with certain examples herein. The program code stores data utilizing this structure which enables rapid access to these data for the transformations described herein.

As illustrated in FIG. 4, case profile data structure 400 includes a parent case profile node 402 associated with a user and one or more child incident entry nodes 404a, 404b, 404c, each corresponding to a structured incident entry submitted by that user. The hierarchical relationship between the parent case profile and child incident entries enables program code executed by the one or more processors to aggregate incident entries associated with a given user into a unified, persistent representation.

In one example, parent case profile node 402 stores a case identifier, a user identifier, an aggregated prioritization score, and pointers to associated child incident entry nodes. Each child incident entry node 404 stores the standardized field values of the corresponding structured incident entry, including incident type, timestamp, actor identifier, impact indicator, mapped legal issue category, and assigned severity value.

Returning to FIG. 1, the hierarchical data structure enables the program code to perform cross-entry analysis by providing the program code of the evaluation engine 114 with access to all incident entries associated with a case profile in a single data retrieval operation. This technical architecture reduces the computational cost of cross-entry analysis relative to systems that require multiple independent queries across unrelated records.

Program code of an evaluation engine 114 generates a plurality of evaluation metrics based on the aggregated structured incident entries stored in the hierarchical case profile data structure. These evaluation metrics are discussed below and can include a severity value (and a severity component score), a documentation metric, a recency metric, a consistency metric, and/or a pattern-based metric.

The program code assigns a severity value to each structured incident entry based on the legal issue category to which the incident type was mapped by mapping layer 110. In one example, severity values are stored in a lookup table indexed by incident type, wherein each incident type is associated with a predefined integer severity value. For example, and without limitation: a compensation-related incident type may be assigned a severity value of 2; a communication-related incident type may be assigned a severity value of 3; and a discrimination-related incident type may be assigned a severity value of 5. These values represent increasing levels of legal severity and may be adjusted in various examples.

The program code generates the severity component score as a function of the severity values assigned to all incident entries in the case profile. In one example, the program code generates the severity component score as a maximum severity value among all incident entries associated with a case profile. In another example, the program code generates the severity component score is a weighted sum, average, or other aggregation function of individual severity values.

The program code generates a documentation metric based on the number and type of supporting materials associated with a case profile. Supporting materials can include, without limitation, uploaded documents, photographs, electronic communications, medical records, or other evidentiary materials submitted in connection with one or more incident entries.

In one example, the program code applies predefined threshold values to the quantity of supporting materials to assign a documentation component score. For example, a case profile with no supporting materials may receive a documentation component score of 0, a case profile with one to two supporting materials may receive a score of 1, and a case profile with three or more supporting materials may receive a score of 2. The program code or an administrator can adjust threshold values and associated scores in various examples.

The program code can generate a recency metric based on whether one or more incident timestamps fall within a predefined recency time window measured from the current date. In one embodiment, the recency time window is defined as a configurable number of days preceding the date of evaluation. The program code can assign a recency component score when at least one incident entry has a timestamp within the defined recency window.

The program code can generate a consistency metric by evaluating the alignment of data field values across the plurality of incident entries associated with a case profile. The consistency metric detects internal inconsistencies in the submitted incident data that may affect the reliability of the case profile. The program code can assign a consistency component score is assigned based on a degree of misalignment detected. In one example, the program code assigns a lower consistency score is assigned when the program code detects a misalignment which exceeds a predefined threshold. The program code can utilize this consistency metric to flag case profiles for manual review prior to prioritization.

In one example, the program code identifies a misalignment when: (a) conflicting actor identifiers are detected across incident entries within the same case profile; (b) incident types are mapped to incompatible or mutually exclusive legal issue categories; or (c) timestamps associated with incident entries reflect an inconsistent temporal sequence that is logically inconsistent with the nature of the reported incidents.

The program code can generates a pattern-based metric by detecting one or more of the following patterns across the plurality of structured incident entries associated with a case profile: recurring incidents and/or temporal escalation. Each type of detection by the program code is discussed below.

The program code detects a recurring incident pattern when a same incident type occurs a number of times that exceeds a predefined frequency threshold within a defined time window. The frequency threshold specifies the minimum number of occurrences required to classify an incident type as recurring. The time window defines the period within which occurrences are counted. In one example, the program code detects this aspect on a recurring basis and this recurring detection triggers an additive adjustment to the pattern-based component score.

The program code can detect temporal escalation by: (a) retrieving the severity values assigned to the incident entries associated with the case profile; (b) ordering the severity values by the timestamps of their respective incident entries; and/or (c) determining whether the ordered severity values exhibit an increasing trend over successive timestamps. For example, the program code can identify an increasing trend when the program code determines that each successive severity value is greater than or equal to the preceding value and the program code detects at least one strictly increasing transition (defined by a pre-defined values). When the program code detects temporal escalation, the program code can trigger an additive adjustment to the pattern-based component score.

As discussed above, the program code scores computed evaluation metrics for a case profile. In FIG. 1, the scoring is depicted as being accomplished by program code comprising a scoring engine 116 (or module), but as aforementioned, the various functionalities can be

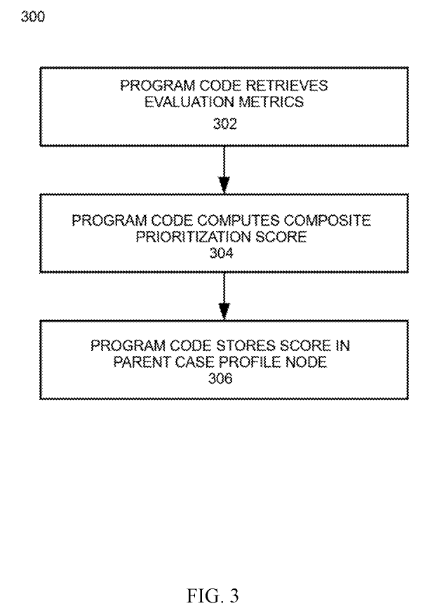

FIG. 3 illustrates a scoring process 300 performed by scoring engine 116 in accordance with an embodiment of the disclosure. In this example, the program code of the scoring engine 116, as illustrated in FIG. 1, retrieves the evaluation metrics for a case profile from evaluation engine 114 (302). The evaluation metrics can include the component scores including but not limited to, severity, documentation, recency, consistency, and/or pattern-based component scores. The program code of scoring engine 116 generates a composite prioritization score for the case profile as a function of the component scores (304). The program code can generate the composite prioritization score as a weighted sum of component scores in accordance with predefined weighting coefficients. The program code can generate the composite prioritization score as an unweighted sum of component scores. The program code can also score using additional scoring functions, including nonlinear functions. Depending on the implementation of the aspects of the examples herein, the composite prioritization score can be capped at a predefined maximum value to normalize scoring across case profiles to prevent any single component from disproportionately dominating the aggregate score. The program code of the scoring engine 116 stores the computed composite prioritization score in the parent case profile node of the hierarchical data structure (306).

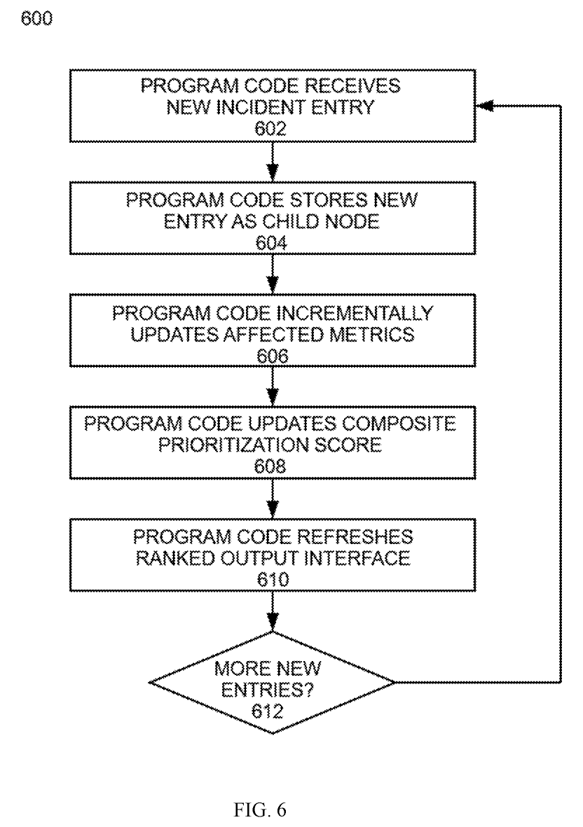

As aforementioned, the program code on the examples herein performs an incremental update process 600, which is illustrated in FIG. 6. The program code executing on one or more processors obtains, via the structured incident entry associated with an existing case profile, a new structured incident entry which conforms to the aforementioned predefined schema (602). The program code stores the structured incident entry is stored as a new child node of the hierarchical case profile data structure associated with the relevant case profile (604). The program code performs incremental updates to the evaluation metrics affected by the newly received incident entry (606). The program code can re-generate only the evaluation metrics that depend on the data fields of the new incident; the program code does not re-generate evaluation metrics that are unaffected by the new entry. Limiting processing only to parameters or values impacted by newly obtained data reduces computational overhead relative to full-re-computation approaches of existing systems in which all metrics are recalculated upon receipt of each new entry. The program code updates the composite prioritization score stored in the parent case profile node to reflect the revised evaluation metrics (608). The program code generates ranked output which reflects the updated composite prioritization score and provides the output through output interface 108 (610).

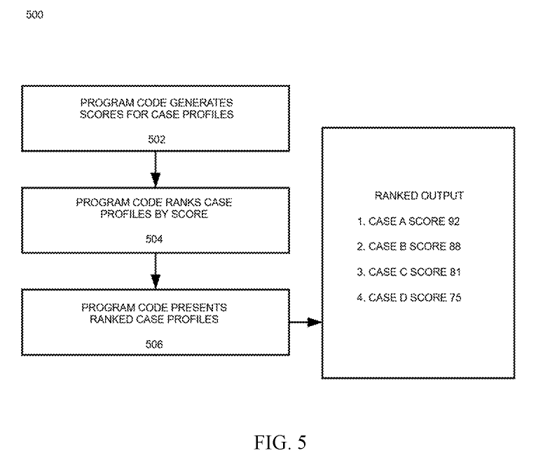

FIG. 5 illustrates how the program code ranks the output provided in FIG. 6. Specifically, FIG. 5 illustrates a prioritization and ranking process 500 in accordance aspects of some of the examples herein. The program code of the scoring engine 116 (FIG. 1) generates a composite prioritization score for each case profile stored in database 106. The program code ranks the case profiles in descending order by their composite prioritization scores, so that case profiles with higher scores are presented first in the output (504). The program code visualizes, in the output interface 108, ranked case profiles for review (506). The output can include the composite prioritization score, the component scores, the number of associated incident entries, and/or any detected patterns for each ranked case profile.

As discussed herein, the user experience is improved through the utilization of the examples herein. The following example, which focuses on the user experience, is provided for purposes of illustration and not limitation. The values assigned by the program code in the examples herein are likewise provided for illustrative purposes only.

FIG. 7 is a workflow 700 provided with a focus on the user. As illustrated in FIG. 7, a user submits a first structured incident entry through the structured intake interface, identifying a compensation-related incident occurring on a first date, involving a named actor, and indicating a moderate impact level (710). Based on obtaining the data in this entry from the user, the program code of the mapping layer 110 maps the compensation incident type to a wage-and-hour legal issue category and assigns a severity value of 2 to the first incident entry (715). The user subsequently submits a second structured incident entry identifying a communication-related incident on a second date, involving the same actor as identified in the first entry, with a moderate-to-high impact level (730). The program code of the mapping layer 110 maps the communication incident type to a hostile work environment legal issue category and assigns a severity value of 3 (740). The user subsequently submits a third structured incident entry identifying a discrimination-related incident on a third date, involving the same actor, with a high impact level (750). The program code of the mapping layer 110 maps the discrimination incident type to a civil rights legal issue category and assigns a severity value of 5 (760). The program code aggregates all three incident entries into the hierarchical case profile data structure as child nodes of the user's parent case profile (770). The program code of the evaluation engine 114 computes various scores (780), including the following: (a) severity component score based on a maximum severity value of 5; (b) documentation component score based on any materials submitted with the entries; (c) recency component score based on whether any incident timestamp falls within the recency window; (d) consistency component score reflecting consistent actor identifier across all three entries; (e) pattern-based component score reflecting: (i) recurring actor involvement across multiple incident entries; and (ii) temporal escalation, as the severity values of 2, 3, and 5 exhibit a strictly increasing trend across successive timestamps. The program code of the scoring engine 116 computes a composite prioritization score that reflects all of the above component scores (790). The program code ranks the case profile and surfaces it for priority review through an output interface 108 (795).

Described herein and computer-implemented methods, computer program products, and computer systems for prioritizing legal intake leads. In some examples, program code executing on one or more processors obtains or receives a plurality of structured incident entries through a predefined input interface, each entry comprising standardized fields including an incident type, a timestamp, an actor identifier, and an impact indicator. A mapping layer maps incident types to legal issue categories using a lookup table stored in memory. Structured incident entries are aggregated into a hierarchical data structure linking child incident entry nodes to a parent case profile node. A plurality of evaluation metrics is computed based on cross-entry analysis of the aggregated entries, including severity, documentation, recency, consistency, and pattern-based metrics. The pattern-based metric is computed by detecting recurring incident patterns based on a frequency threshold and detecting temporal escalation based on increasing severity values across successive timestamps. A rule-based scoring engine generates a composite prioritization score as a function of the evaluation metrics. Evaluation metrics and the composite prioritization score are updated incrementally upon receipt of new incident entries without recomputing unaffected metrics. Case profiles are ranked by prioritization score and output for review.

Referring now to FIG. 8, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the one or more processors that execute the program code can each comprise a cloud computing node 10 (FIG. 8) and if not a cloud computing node 10, then one or more general computing nodes that include aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. The operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

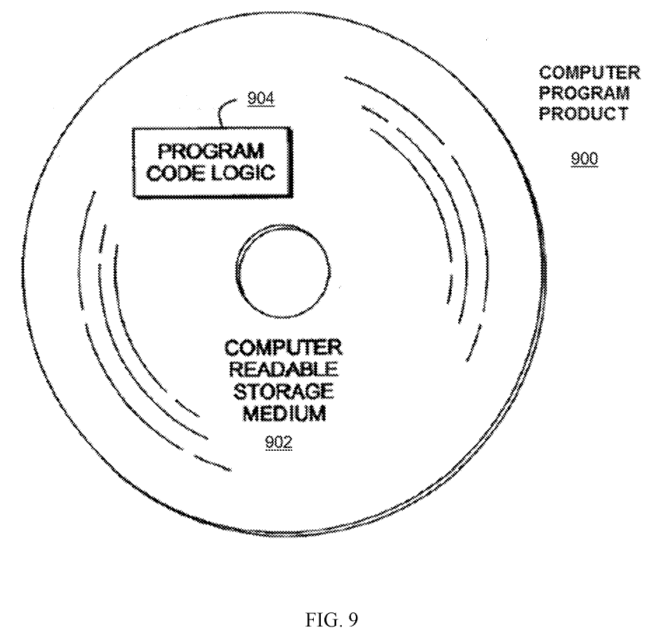

In certain embodiments, the program logic including code can be stored in the storage, or memory. In certain other embodiments, the program logic can be implemented in the circuitry. Using the processing resources of a resource FIG. 8 to execute software, computer-readable code or instructions, does not limit where this code can be stored. Referring to FIG. 9, in one example, a computer program product 900 includes, for instance, one or more non-transitory computer readable storage media 902 to store computer readable program code means or logic 904 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a "circuit," "module" or "system". Furthermore, aspects of the technique may take the form of a computer program product embodied in one or more computer readable medium(s) having computer readable program code embodied thereon.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for automatically evaluating, transforming, and prioritizing data, comprising:
generating, by one or more processors, a user interface comprising a predefined structured input interface;
continuously obtaining, by the one or more processors, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry;
based on obtaining the given incident entry, mapping, by the one or more processors, utilizing pre-defined data object stored in a mapping layer communicatively coupled to the user interface, based on an incident type of the given incident entry, the given incident entry to one or more legal issue categories;
identifying, by the one or more processors, a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface;
updating, by the one or more processors, the hierarchical data structure by generating a child node representing the given incident entry and the mapped one or more legal issue categories;
based on the updated hierarchical data structure, generating, by the one or more processors, based on performing a cross-entry analysis across a portion of the update hierarchical data structure, evaluation metrics for one or more structured incident entries stored in the hierarchical data structure wherein the one or more structured incident entries comprise the given incident entry;
applying, by the one or more processors, a rule-based scoring engine to generate a composite prioritization score for the given incident entry as a function of the evaluation metrics; and
outputting, by the one or more processors, ranked case profiles through an output interface, wherein a case profile of the case profiles is associated with the given incident entry in a context of the updated hierarchical data structure, wherein the case profiles are ranked based on their respective composite prioritization scores.

2. The computer-implemented method of claim 1, wherein additional standardized fields are selected from the group consisting of: a timestamp, an actor identifier, and an impact indicator.

3. The computer-implemented method of claim 1, wherein the pre-defined data object comprises a lookup table stored in a memory.

4. The computer-implemented method of claim 1, wherein identifying the parent node, comprises:
searching, by the one or more processors, the hierarchical data structure to locate the parent node; and
based on the searching failing to locate the parent node, generating, by the one or more processors, the parent node.

5. The computer-implemented method of claim 1, wherein the parent node comprises a mapped legal issue category.

6. The computer-implemented method of claim 1, wherein the evaluation metrics are selected from the group consisting of: a severity metric, a documentation metric, a recency metric, a consistency metric, and a pattern-based metric.

7. The computer-implemented method of claim 1, wherein the continuously obtaining comprises obtaining a new structured incident entry associated with the case profile of the incident entry, the method further comprising:
determining, by the one or more processors, which evaluation metrics are impacted by the new structured incident entry;
updating, by the one or more processors, based on the determining a portion of the evaluation metrics; and
utilizing, by the one or more processors, the updated portion of the evaluation metrics to updated the composite prioritization score.

8. The computer-implemented method of claim 7, further comprising:
generating and outputting, by the one or more processors, updated ranked case profiles through an output interface based on updated the composite prioritization score.

9. The computer-implemented method of claim 7, wherein the updating of the portion of the evaluation metrics comprises:
updating the portion of the evaluation metrics incrementally based on a pre-configured schedule; or
updating the portion of the evaluation metrics incrementally based timing of the continuously obtaining.

10. The computer-implemented method of claim 6, wherein the evaluation metrics comprise the pattern-based metric and wherein generating the pattern-based metric comprises detecting a recurring incident pattern based on a given incident type occurring a number of times exceeding a predefined frequency threshold within a defined time window.

11. The computer-implemented method of claim 6, wherein the evaluation metrics comprise the pattern-based metric and wherein generating the pattern-based metric comprises detecting a temporal escalation, wherein the detecting comprises:
determining, by the one or more processors, by ordering severity values associated with incident entries by their respective timestamps; and
identifying, by the one or more processors, an increasing trend in severity values across successive timestamps.

12. The computer-implemented method of claim 11, wherein detecting the recurring incident pattern comprises:
identifying, by the one or more processors, incident entries within the hierarchical data structure having a common incident type;
counting, by the one or more processors, the identified incident entries occurring within the defined time window; and
classifying, by the one or more processors, the common incident type as recurring based on a number of the identified entries exceeding the predefined frequency threshold.

13. The computer-implemented method of claim 6, wherein the evaluation metrics comprise the pattern-based metric and wherein generating the pattern-based metric comprises detecting a temporal escalation, wherein the detecting comprises:
retrieving, by the one or more processors, from the hierarchical data structure severity values assigned to incident entries associated with the case profile;
ordering, by the one or more processors, the severity values by timestamps of their respective incident entries; and
identifying, by the one or more processors, an increasing trend in severity values when at least one successive severity value is strictly greater than a preceding severity value.

14. The computer-implemented method of claim 6, wherein the evaluation metrics comprise the consistency metric and wherein generating the consistency metric comprises
evaluating, by the one or more processors, alignment of standardized field values across the structured incident entries;
detecting, by the one or more processors, a misalignment based on determining that a condition is satisfied from the group consisting of: conflicting actor identifiers are present across the structured incident entries, incident types associated with the structured incident entries are mapped to incompatible legal issue categories, and timestamps associated with the structured incident entries reflect an inconsistent temporal sequence; and
decreasing, by the one or more processors, the consistency metric comprising a consistency component score based on the detected misalignment exceeding a predefined threshold.

15. The computer-implemented method of claim 6, wherein the evaluation metrics comprise the severity metric, wherein the data object comprises a lookup table, and wherein generating the severity metric comprises:
utilizing, by the one or more processors, the lookup table, to obtain values indexed by incident type, wherein each incident type is associated with a predefined severity value representing a level of legal severity; and
based on the incident time from the lookup table, assigning, by the one or more processors, the severity metric.

16. The computer-implemented method of claim 1, further comprising:
determining, by the one or more processors, that at least one composite prioritization score of the composite prioritization scores exceeds a maximum value; and
automatically reducing, by the one or more processors, the composite prioritization score to a value below the maximum value.

17. The computer-implemented method of claim 6, wherein the evaluation metrics comprise the documentation metric, and wherein generating the documentation metric comprises:
determining, by the one or more processors, a number of supporting materials associated with the case profile;
comparing, by the one or more processors, the number of supporting materials to a pre-determined threshold values with pre-determined documentation metrics to assign the documentation metric.

18. The computer-implemented method of claim 6, wherein the evaluation metrics comprise the recency metric, and wherein generating the recency metric comprises:
determining, by the one or more processors, if at least one timestamp for the given structured entry falls within a predefined recency time window measured from a date of evaluation.

19. A computer system for automatically evaluating, transforming, and prioritizing data, the computer system comprising:
a memory; and
one or more processors in communication with the memory, wherein the computer system is configured to perform a method, said method comprising:
generating, by the one or more processors, a user interface comprising a predefined structured input interface;
continuously obtaining, by the one or more processors, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry;
based on obtaining the given incident entry, mapping, by the one or more processors, utilizing pre-defined data object stored in a mapping layer communicatively coupled to the user interface, based on an incident type of the given incident entry, the given incident entry to one or more legal issue categories;
identifying, by the one or more processors, a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface;
updating, by the one or more processors, the hierarchical data structure by generating a child node representing the given incident entry and the mapped one or more legal issue categories;
based on the updated hierarchical data structure, generating, by the one or more processors, based on performing a cross-entry analysis across a portion of the update hierarchical data structure, evaluation metrics for one or more structured incident entries stored in the hierarchical data structure wherein the one or more structured incident entries comprise the given incident entry;
applying, by the one or more processors, a rule-based scoring engine to generate a composite prioritization score for the given incident entry as a function of the evaluation metrics; and
outputting, by the one or more processors, ranked case profiles through an output interface, wherein a case profile of the case profiles is associated with the given incident entry in a context of the updated hierarchical data structure, wherein the case profiles are ranked based on their respective composite prioritization scores.

20. A computer program product for automatically evaluating, transforming, and prioritizing data, the computer program product comprising:
one or more computer readable storage media and program instructions collectively stored on the one or more computer readable storage media to perform a method comprising:
generate a user interface comprising a predefined structured input interface;
continuously obtain, via the user interface, data comprising incident entries, wherein the obtaining comprises automatically applying logic rules in the user interface to enforce structural aspects of the structured input interface to aggregate the data into standardized fields, wherein the standardized fields comprise an incident type, wherein the continuously obtaining comprises obtaining a given incident entry;
based on obtaining the given incident entry, map, utilizing pre-defined data object stored in a mapping layer communicatively coupled to the user interface, based on an incident type of the given incident entry, the given incident entry to one or more legal issue categories;
identify a parent node comprising a profile for the user in a hierarchical data structure, wherein the hierarchical data structure comprises parent nodes associated with user profiles and child incident nodes linked to parent nodes each comprise a structured incident entry of the incident entries obtained via the user interface;
update the hierarchical data structure by generating a child node representing the given incident entry and the mapped one or more legal issue categories;
based on the updated hierarchical data structure, generate, based on performing a cross-entry analysis across a portion of the update hierarchical data structure, evaluation metrics for one or more structured incident entries stored in the hierarchical data structure wherein the one or more structured incident entries comprise the given incident entry;
apply a rule-based scoring engine to generate a composite prioritization score for the given incident entry as a function of the evaluation metrics; and
output ranked case profiles through an output interface, wherein a case profile of the case profiles is associated with the given incident entry in a context of the updated hierarchical data structure, wherein the case profiles are ranked based on their respective composite prioritization scores.
